(19) United States
(12) Patent Application Publication
(10) Pub. No.: US 2022/0029526 A1
(43) Pub. Date: Jan. 27, 2022

(54) DEVICE AND METHOD FOR DISCHARGING A DC LINK CAPACITOR

(71) Applicant: ZF Friedrichshafen AG, Friedrichshafen (DE)

(72) Inventors: Marco DENK, Memmelsdorf (DE); Stefan HAIN, Speichersdorf (DE)

(73) Assignee: ZF Friedrichshafen AG, Friedrichshafen (DE)

(21) Appl. No.: 17/311,257

(22) PCT Filed: Nov. 5, 2019
(86) PCT No.: PCT/EP2019/080146

§ 371 Date: Jun. 4, 2021

(51) Int. Cl. H02M 1/32; H02J 7/34

(52) U.S. Cl. CPC H02M 1/32; B60L 3/0092; H02J 7/345

(57) ABSTRACT

The present invention relates to a device for discharging a DC link capacitor, the device having a discharging unit for discharging the DC link capacitor, the discharging unit being connected or connectable between two connection terminals of the DC link capacitor, discharging of the DC link capacitor being controllable by means of a control voltage applied to a control input of the discharging unit. The device also comprises a control unit, which is designed to apply the control voltage to the control input of the discharging unit, wherein the control unit is further designed to vary the control voltage during a discharging process or at the start of a process for discharging the DC link capacitor.

The present invention relates to a device and a method for discharging a DC link capacitor according to the independent claims.

A DC link capacitor in a power electronics drive train should be able to be discharged in a controlled manner in the event of an error for safety reasons. A permanent passive discharge by high amperage resistors or a redundant active discharge circuit is used for this. The active discharge circuit can comprise, e.g., numerous resistors, which absorb the energy from the DC link capacitor, and/or a high voltage semiconductor switch, which combines the load resistors with the DC link capacitor as needed. This technology can be used for systems of up to 400V.

For 800V systems, there is the problem that the high voltage semiconductor switches and the load resistors are significantly larger, because the DC link capacitor contains four times the energy at the same capacitance.

Based on this, the present invention results in an improved device and an improved method for discharging a DC link capacitor according to the independent claims. Advantageous embodiments can be derived from the dependent claims and the following description.

A device for discharging a DC link capacitor is presented, wherein the device comprises the following features:
a discharge unit for discharging the DC link capacitor, wherein the discharge unit can be or is interconnected between two terminal clamps in the DC link capacitor, wherein discharging the DC link capacitor can be controlled by a control voltage applied to a control input on the discharge unit; and
a control unit configured to supply the control voltage to the control input on the discharge unit, wherein the control unit is also configured to vary the control voltage during a discharge process or at the start of a discharge process for the DC link capacitor.

A discharge unit can be a unit or element that enables current to flow in response to a control signal to discharge the DC link capacitor in a discharge process. By way of example, the discharge unit can be a semiconductor component, in particular for power electronics. A control unit can be a unit, in particular an electronic unit, that generates the control voltage in accordance with a predefined rule or circuit topology. The control voltage can be generated numerically or through circuitry. By way of example, the discharge unit can be a component or element in an inverter.

The approach proposed herein is based on the knowledge that a discharge unit can exhibit different connection behaviors, such that when the control input on the discharge unit is supplied with a variable control voltage, an operating point of the discharge unit is activated, also resulting in a reliable discharging of the DC link capacitor. The approach proposed herein has the advantage of being able to reliably discharge the DC link capacitor in different scenarios in response to the control signal or control voltage using technically simple and inexpensive means.

The approach presented herein therefore offers a solution to the problem of how the redundant active discharge according to one embodiment can be obtained by appropriately controlling semiconductor switches serving as part of a discharge unit, e.g. as part of the inverter. Corresponding load resistors and an associated high voltage load resistor are not necessary for this. The power semiconductor(s) forming an embodiment of the discharge unit is/are operated in a linear range for this, for example, and a defined resistance and discharge current for discharging the DC link capacitor are set in this manner.

According to one aspect of the approach presented herein, a particularly simple and functional control process for power semiconductors serving as an embodiment of the discharge unit can therefore be implemented in order to carry out a controlled active discharge of the DC link capacitor. A novel control method for the discharge unit, e.g. in the form of a power semiconductor, is therefore proposed according to one embodiment of the approach presented herein, in order to be able to integrate the function of a redundant, active discharge of the DC link capacitor in the control thereof.

According to a particularly advantageous embodiment, the control unit can be designed to vary the control voltage from a low voltage level to a high voltage level. In this manner, the discharge unit can advantageously be controlled such that the DC link capacitor is discharged as quickly and reliably as possible via the discharge unit.

According to another embodiment, the control unit can also be designed to vary the control voltage evenly, linearly, and/or monotonically, in particular strictly monotonically. As a result, it can be ensured that the discharge unit is activated long enough in an optimal voltage range for the control voltage that the DC link capacitor can be reliably and quickly discharged. At the same time, such a control voltage can be easily and efficiently provided.

An embodiment of the approach proposed herein in which the control unit contains an RC link for determining a voltage level of the control voltage is particularly advantageous. Such an embodiment can be obtained easily in terms of the circuitry.

According to another embodiment of the approach proposed herein, the control unit can be designed to cause a voltage jump in the control voltage during or at the start of the discharge process, and/or cause a voltage jump in the control voltage after completion of the discharge process. Such an embodiment has the advantage of controlling the discharge unit such that there is no intentional discharge of the DC link capacitor prior to the desired start of the discharge process, and/or the discharge unit can be quickly brought to a state in which the DC link capacitor can be recharged after completion of the discharge process.

In this context, an embodiment of the approach presented herein is particularly advantageous in which the control unit is configured to set the control voltage to 0 volts at the start of the discharge process, in particular starting from a minimum value at the control input on the discharge unit prior to starting the discharge process, and/or wherein the control unit is designed to set the control voltage to a minimum value after completion of the discharge process, in particular based on a maximum value at the control input on the discharge unit upon completion of the discharge process. In this manner, the discharge unit can be controlled such that the discharging of the DC link capacitor takes place with the greatest reliability at a desired discharge time or during a discharge time interval, whereas discharging the DC link capacitor at other times or time intervals can be reliably prevented.

According to another embodiment of the approach proposed herein, the discharge unit can be designed as a semiconductor switch, in particular a power semiconductor switch. In this manner, discharging the DC link capacitor can be quickly and easily activated. At the same time, this semiconductor switch be part of an inverter in the DC link, such that components already used in the DC link can be used for an additional function, and additional, separate components can be eliminated, resulting in a very inexpensive implementation of the approach presented herein. Particularly advantageously, the semiconductor switch can also be operated in a linear (characteristic) range, such that the technical functions of the semiconductor switch can be used as efficiently as possible for the discharge process for the DC link, e.g. for converting the electrical energy stored in the DC link capacitor into thermal energy.

The discharge unit can also be a transistor according to another embodiment of the approach presented herein, in particular a MOSFET transistor or an IGBT. Such an embodiment has the advantage of a particularly quick and reliable activation of the discharge unit for discharging the DC link capacitor, wherein one component in the DC link, for example, can also be used as the discharge unit, thus reducing production costs for implementing the approach presented herein.

In another embodiment of the approach presented herein, the control unit can also be designed to determine the control voltage based on the temperature of the discharge unit or a component in the discharge unit. Such an embodiment offers the advantage of activating the appropriate control voltage at an optimal operating point for the discharge unit as quickly as possible, such that the DC link capacitor can be discharged as quickly as possible.

The approach proposed herein can be implemented particularly quickly and economically if a circuit topology is used in which the control unit has at least two resistors, wherein one of the resistors can be connected in parallel to the other resistor, or coupled or can be coupled to the control input on the discharge unit, wherein the control unit has a capacitor that is or can be interconnected between the control input on the discharge unit and a contact on the DC link capacitor, in particular wherein the capacitor has a second switch for a parallel connection of the capacitor between the control input and the contact on DC link capacitor. Such an embodiment of the approach presented herein has the advantage of being able to provide the desired change in the control voltage during the discharge process, or to initiate the discharge process with technically simple means.

An embodiment of the approach proposed herein can be particularly efficiently used in a DC link for transmitting electricity from an energy source to an actuator, wherein the DC link contains a DC link capacitor and a device according to one of the variations presented herein coupled to the DC link capacitor, in particular wherein the device (also) uses at least one component that is also used by an inverter connected to the DC link capacitor. The component used by the inverter can then be used as the discharge unit for the device. Such an embodiment offers the advantage of efficiently, quickly, and reliably discharging the DC link capacitor with the device.

An embodiment of the approach presented herein in the form of a method for discharging a DC link capacitor by means of one of the variations of a device presented herein is also advantageous, wherein the method comprises the following step:
supplying the control input on the discharge unit with a control voltage, wherein the control voltage is varied during or at the start of the discharge process for the DC link capacitor.

Advantages of the approach presented herein can also be obtained quickly and efficiently with such an embodiment.

An embodiment of the approach presented herein in the form of a control unit is also advantageous, which is configured to execute and/or control the step in a variation of the method presented herein in a corresponding unit.

A control unit can be an electric device that processes electric signals, e.g. sensor signals, and outputs control signals on the basis thereof. The control unit can have one or more hardware and/or software interfaces. A hardware interface can be part of an integrated circuit, for example, in which the functions of the device are implemented. The interfaces can also be integrated circuits or at least partially comprised of discrete components. A software interface can be one of numerous software modules, e.g. on a microcontroller.

A computer program comprising program code is also advantageous, which can be stored on a machine-readable medium, e.g. a solid state memory, a hard disk, or an optical memory, and is used to execute the method according to any of the embodiments described above, when the program us run on a computer or control unit.

The invention shall be explained in greater detail by way of example, based on the attached drawings. Therein:

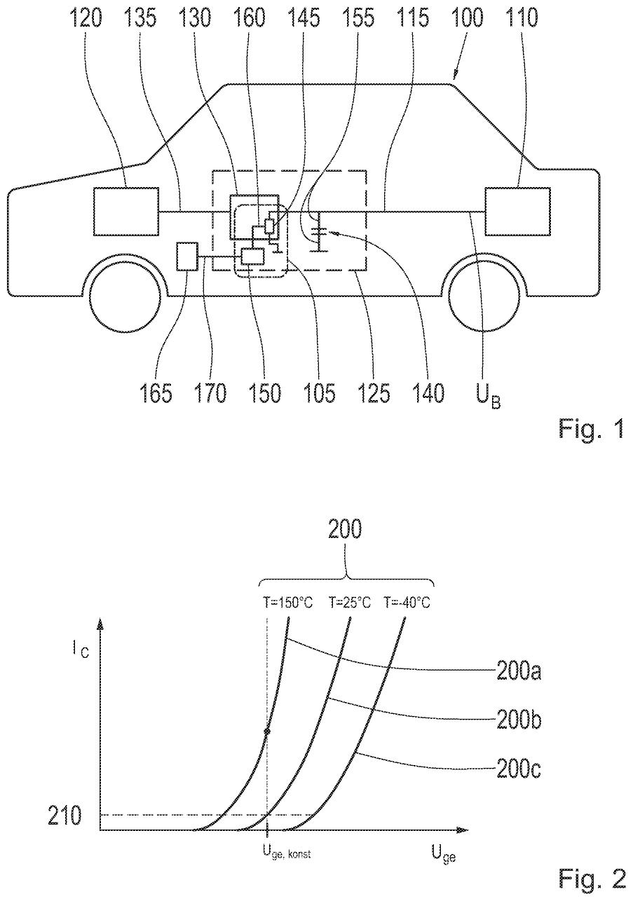

FIG. 1 shows a schematic illustration of a vehicle in which a device for discharging a DC link capacitor can be used according to an exemplary embodiment;

FIG. 2 shows a graph plotting the control behavior of a power semiconductor functioning as a discharge unit;

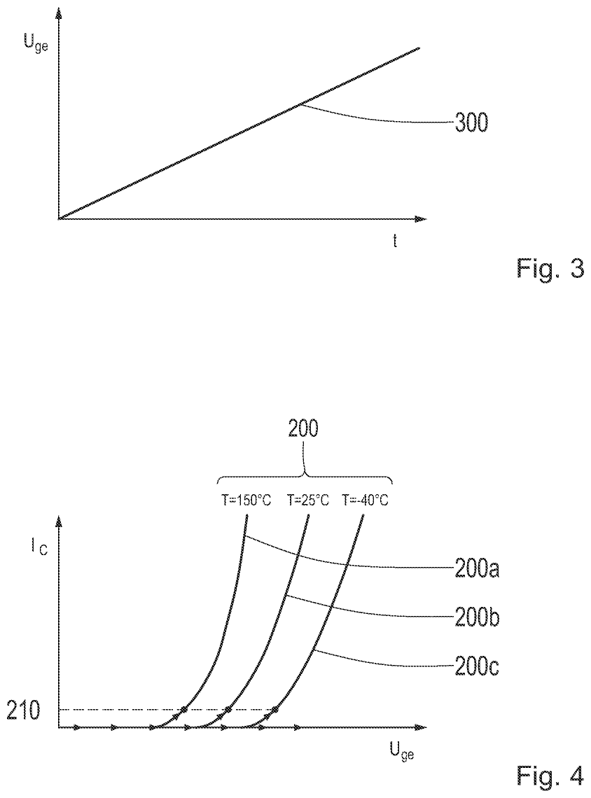

FIG. 3 shows a schematic illustration of a control voltage curve;

FIG. 4 shows a graph corresponding to the diagram in FIG. 2, wherein it is clear therein that an optimal operating point or optimal gate voltage is obtained on a curve through the variable gate voltage;

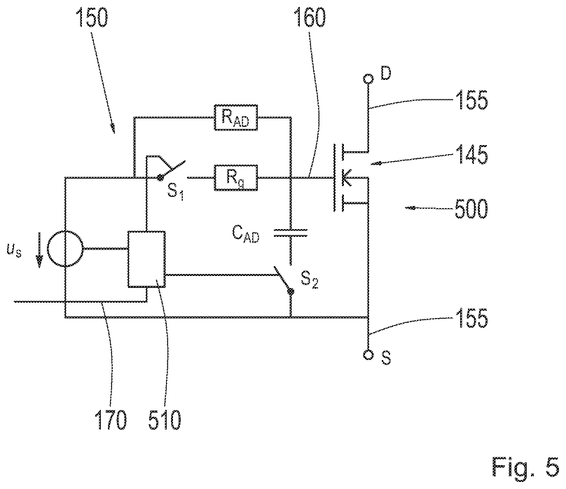

FIG. 5 shows one possible circuit topology that can be used to implement the approach presented herein easily and inexpensively;

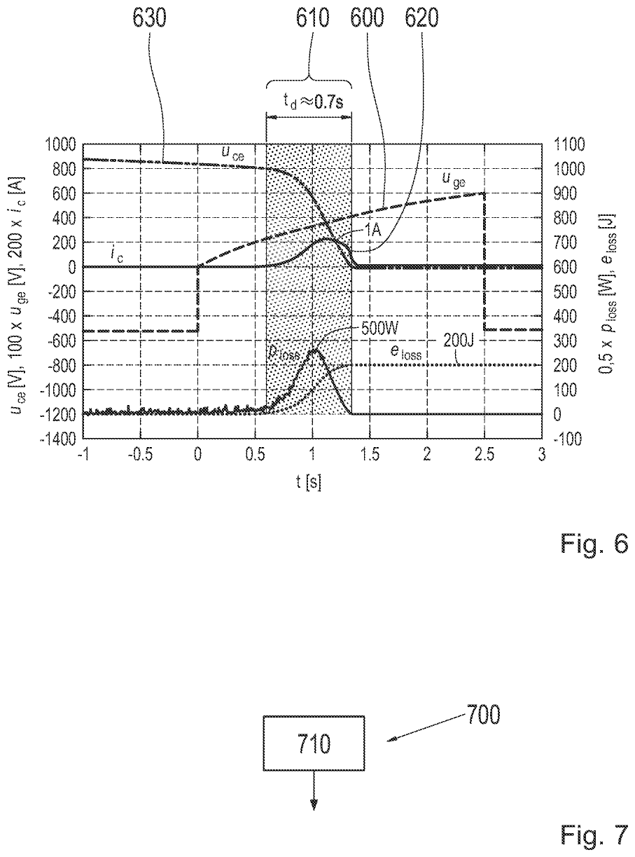

FIG. 6 shows a graph plotting different electrical values over time to deepen the understanding of the function of the circuit in FIG. 5; and

FIG. 7 shows a flow chart for a method according to an exemplary embodiment.

The same or similar reference symbols are used in the following description of preferred exemplary embodiments of the present invention for the elements having similar functions in the various figures, wherein there shall be no repetition of the descriptions of these elements.

FIG. 1 shows a schematic illustration of a vehicle 100 in which a device 105 for discharging a DC link capacitor according to an exemplary embodiment can be used. The vehicle 100 is, e.g. a hybrid or electric vehicle. The vehicle 100 is supplied with electricity from a battery or rechargeable battery functioning as a power storage unit 110, which feeds a voltage U_{B} of 400 volts, or even 800 volts in newer vehicles, to a power supply system 115 in the vehicle 100. To then be able to operate a drive motor 120 in the vehicle 100 with this energy from the power storage unit 110, a DC link 125 with an inverter 130 is often needed to generate an AC voltage from the DC voltage sent from the power source 110 to the power supply system 115 in the vehicle, in particular a multi-phase AC voltage, in a drive power supply system 135 for operating the drive motor 120. This inverter 130 can contain one or more bridge circuits, not shown in FIG. 1 for purposes of clarity, to obtain the appropriate AC voltage for the drive power supply system 135 from the DC voltage U_{B} from the power supply system 115.

There is a DC link capacitor 140 for preventing or smoothing out fluctuations in the voltage U_{B} in the power supply system 115 when the load to the drive motor 120 fluctuates. This DC link capacitor 140 is usually configured to receive large amounts of energy, in order to absorb these fluctuations in the voltage U_{B} in the power supply system 115. If, however, the electrical system in the vehicle 100 malfunctions, e.g. due to a short circuit or an electrical defect, is may be necessary, for safety purposes, to discharge the DC link capacitor 140 as quickly as possible, in order to minimize the risk of the vehicle 100 catching on fire, or an electrical shock to the occupants of the vehicle 100 caused by the high voltage still contained in the DC link capacitor 140. A protective circuit is usually used for this, such as that represented by the device 105 for discharging the DC link capacitor 140 presented herein.

The device 105 for discharging the DC link capacitor 140 contains a discharge unit 145 and a control unit 150. The discharge unit 145 can be interconnected between terminal clamps 155 on the DC link capacitor 140, wherein the discharging of the DC link capacitor 140 can be controlled by the discharge unit 145 by means of a control voltage applied to a control input 160. The control unit 150 is configured to provide the control voltage to the control input 160 on the discharge unit 145, wherein the control unit 150 provides the control voltage such that the control voltage is varied during the discharge process of, or for discharging (i.e. at the start of the discharging), the DC link capacitor 140.

To initiate discharging the DC link capacitor 140, the corresponding control voltage U_{ge} can be generated in the control unit 150 in response to a malfunction detected by an error detection unit 165 and transmitted to the control unit 150 by means of an error signal 170, e.g. a defect in the electrical system in the vehicle 100, and sent to the control input 160 on the discharge unit 145, as shall be described in greater detail below.

If a power semiconductor is then used as the discharge unit 145, which is, e.g. part of the inverter 130 or a bridge circuit in the inverter 130, there may be difficulties in obtaining a controlled activation of this power semiconductor for ensuring that it only conducts a very small current (a few hundred milliamperes) instead of its nominal current (a few hundred amperes). For this, the gate voltage U_{ge} for this power semiconductor (i.e. the voltage between the gate and the source connection for the power semiconductor used as the discharge unit 145), which sets the current flow I in the power semiconductor, should be set to a specific constant value (U_{ge.konst}). Because the gate voltage U_{ge} necessary for a desired, controlled, low discharge current depends on numerous parameters such as temperature and production tolerances, active discharge by applying a previously defined gate voltage U_{ge} is not possible.

FIG. 2 shows a graph illustrating the control behavior of a power semiconductor acting as a discharge unit 145, in which the gate voltage U_{ge} is plotted on the x-axis, and the current I_{C} flowing through the power semiconductor is plotted on the y-axis. Three curves 200 are also plotted in the graph, wherein the first 200a curve 200 shows the current flow I_{C} as a function of the gate voltage U_{ge} at a temperature of 150° C. in the power semiconductor, a second 200b curve 200 shows the current flow I_{C} as a function of the gate voltage U_{ge} at a temperature of 25° C. in the power semiconductor, and a third 200c curve 200 shows the current flow I_{C} as a function of the gate voltage U_{ge} at a temperature of −40° C. in the power semiconductor. It is clear from FIG. 2 that the discharge current 210 necessary for discharging the DC link capacitor 140 is only reliably reached when the power semiconductor is at a temperature of 25° C.; if the power semiconductor is at a temperature of −40° C., the constant gate voltage U_{ge} is too low, while at a temperature of 150° C., the constant gate voltage U_{ge} is too high.

FIG. 2 thus illustrates the problem through the example of a reliable control of the discharge unit 145 using a power semiconductor as the discharge unit at varying temperatures, which have the greatest effect on the discharge current. FIG. 2 therefore illustrates the problems encountered with an uncontrolled discharge current I_{C} with a constant gate voltage (U_{ge.konst}) in a discharge unit 145 in the form of a power semiconductor, depending on the temperature.

In other words, in the exemplary embodiment shown in FIG. 2, the constant gate voltage (U_{ge.konst}) is set for a temperature of 25° C., such that the desired discharge current I_{C} flows. If, however, the semiconductor is too hot (T=150° C.), the discharge current that flows through the semiconductor(s) in the discharge unit 145 is too high, which could result in damaging or destroying it. The problem with low temperatures (T=−40° C.) is that the gate voltage is not high enough to open the electron channel in the semiconductor functioning as the discharge unit 145, and no discharge current I_{C} flows. As a result, an active discharge via the power semiconductor functioning as the discharge unit 145 cannot be used.

A novel control method according to an exemplary embodiment is proposed to address this problem of obtaining the parameter-dependent gate voltage for a constant and controlled discharge current. In this case, the discharge unit 145, e.g. in the form of a semiconductor, is not controlled with a constant gate voltage, but instead with a variable control voltage, e.g. a gate voltage ramp.

FIG. 3 shows a schematic illustration of a curve 300 for the control voltage that can be sent to the control input 160 on the discharge unit 145 according to one exemplary embodiment of the approach presented herein. Time t is plotted on the x-axis, and the gate voltage U_{ge} is plotted on the y-axis in FIG. 3. The linear or monotone, or even strictly monotone incline of the gate voltage U_{ge} over time t can be seen therein, wherein the time at the origin corresponds to the time at which the discharge process is activated, e.g. in response to the error signal 170. The gate voltage U_{ge} therefore forms a variable control voltage or gate voltage ramp for the control input 160.

The use of such a variable gate voltage U_{ge} as the control voltage at the control input 160, e.g. in the form of the gate voltage ramp according to the approach presented herein, allows the control voltage to be increased over time with a fixed gradient, such that all of the relevant gate voltages U_{ge} are eventually obtained. This control results in the gate voltage U_{ge} at the semiconductor functioning as the discharge unit 145 at some point opening the electron channel and the optimal discharge current I_{C} flowing through the discharge unit 145 in the form of the semiconductor, independently of its temperature and other parameters, such that the DC link capacitor 145 can be discharged.

FIG. 4 shows a graph corresponding to the graph in FIG. 2, wherein it can be seen therein that an optimal operating point, or an optimal gate voltage, is obtained on a curve 200 through the variable gate voltage U_{ge}, independently of the current temperature of the semiconductor functioning as the discharge unit 145, which results in opening the discharge unit 145 in the form of a semiconductor, such that the DC link capacitor 130 can be reliably and quickly discharged. An optimal control of the semiconductor functioning as a discharge unit 145 is therefore depicted in FIG. 4 by the exemplary variable gate voltage ramp functioning as the control voltage at the control input 160. The desired or necessary discharge current 210 is therefore quickly and reliably obtained for every temperature of the semiconductor functioning as the discharge unit 145.

As the ramp inclines, it is possible to set how fast the electron channel in the semiconductor functioning as the discharge unit 145 is to opened, and therefore how quickly the discharge process should be carried out for the DC link capacitor 140.

FIG. 5 shows one possible circuit topology 500 that can be used to simply and economically implement the approach presented herein. The circuit topology 500 can be understood to be a circuitry for generating the variable control voltage, e.g. in the form of a gate voltage ramp. The control voltage or gate voltage ramp can also be obtained by other means, e.g. through a numerical or digital control of corresponding voltage sources. The circuitry 500 shown in FIG. 5 offers a very simple means for implementing the approach proposed herein.

The control circuit or control unit 150 for the semiconductor (functioning as a discharge unit 145) is supplemented with four additional components, specifically a first switch S1, a second switch S2, a capacitor C_{AD}, and a resistor R_{AD}, wherein the two switches S1 and S2, for example, can be closed or opened depending on the error signal 170, by a switch control unit 510. A semiconductor or power semiconductor (e.g. a MOSFET power transistor) is used here as the discharge unit 145, which can also be part of the inverter 130, e.g. a bridge circuit in the inverter 130 for converting the DC voltage U_{B} to AC voltage for operating the drive motor 120.

In normal switching operation (i.e. without errors), the first switch S1 is closed, and the second switch S2 is open. Because the resistor R_{AD} is selected such that its resistance is much greater (e.g. by a factor of 10) than that of the gate resistor R_{g}, the switching behavior of the semiconductor functioning as the discharge unit 145 is not affected by the parallel connection of the resistors R_{AD} and R_{g}. The capacitor C_{AD} is inactive when the second switch S2 is open. If the DC link, or the DC link capacitor is to be discharged, this is indicated by the error signal 170, and the control unit 410 activates a new voltage source, in order to switch the control voltage Us to a positive control voltage, wherein the first switch S1 is opened, and the second switch S2 is closed. Because the capacitance of the capacitor C_{AD} is advantageously much greater (e.g. by a factor of 10) than the gate-source capacitance of the semiconductor functioning as the discharge unit 145, the voltage of the gate-source capacitor is immediately adjusted to the voltage of the capacitor C_{AD} (e.g. through a typical jump from −5V to 0V). The rest of the curve for the gate voltage U_{ge} is determined by the charging of the RC time link comprising the resistor R_{AD} and the capacitor C_{AD}, by means of which the desired gate voltage ramp U_{ge} is obtained, e.g. corresponding to the graph in FIG. 4.

FIG. 6 shows a graph of different electrical values plotted on the y-axis on the left (voltages U_{ce}, U_{ge} and current I_{C}) and on the right (power losses or energy losses) over time t plotted on the x-axis, to better understand the functioning of the circuit in FIG. 5. The discharge concept for the approach presented herein is depicted on the basis of the measurement results and a evidence of the functionality of the control-integrated, active discharge concept presented herein.

At time t=0, the discharge process is activated, at which point the gate voltage (curve 600) jumps at time 0 seconds to 0V. The gate voltage ramp subsequently increases. At 610, the channel in the semiconductor functioning as the discharge unit 145 begins to open, and a controlled discharge current (curve 620) flows, with a maximum amperage of 1A. The voltage of the DC link U_{ce} (line 630) decreases through the discharge current I_{C} within a discharge interval td of 0.7 seconds from 800V to 0V. A power loss pₗₒₛₛ of 500 W is obtained at an energy loss eₗₒₛₛ of 200 J.

One important aspect of the approach presented herein could be that the control of the discharge unit (in the form of a semiconductor here) with a variable control voltage, e.g. a gate voltage ramp, can be used to trigger an active discharging of the DC link capacitor 140. The variable control voltage or ramp can be generated by different variables, e.g. a powered RC link or a defined current source. The great advantage of such an exemplary embodiment is that all of the different types of discharge units, e.g. advantageous types of semiconductors (Si-IGBTs, Si-MOSFETs, and SiC-MOSFETS) can be used in numerous relevant voltages (650V, 1200V, 1700V) to obtain a redundant, control-integrated, active discharge circuit corresponding to the concept proposed herein.

FIG. 7 shows a flow chart for an exemplary embodiment of a method 700 for discharging a DC link capacitor by means of a variation of any of the devices presented herein, wherein the method 700 comprises the step 710 of providing a control voltage to the control input on the discharge unit, wherein the voltage is supplied such that the control voltage is varied during a discharge process or at the start of a discharge process for the DC link capacitor.

The exemplary embodiments described above and shown in the figures are selected merely by way of example. Different exemplary embodiments can be combined with one another in their entirety or with respect to individual features. One exemplary embodiment can also be supplemented by the features of another exemplary embodiment.

Furthermore, steps can be repeated in the method or carried out in an order other than that in the description.

If an exemplary embodiment comprises an “and/or” conjunction between a first feature and a second feature, this can be read to mean that the exemplary embodiment according to one embodiment comprises both the first feature and the second feature, and comprises either just the first feature or just the second feature according to another embodiment.

### REFERENCE SYMBOLS

100 vehicle
105 discharge device
110 power storage unit
115 power supply system
120 drive motor
125 DC link
130 inverter
135 drive power supply system
140 DC link capacitor
145 discharge unit
150 control unit
155 terminal clamps
160 control input
165 error detection unit
170 error signal
200, 200a, 200b, 200c curves
210 discharge current
300 control voltage curve
500 circuit topology
510 switch control unit
S1 first switch
S2 second switch
CAD capacitor
RAD resistor
600 curve
610 curve
620 curve
630 curve
700 method for discharging a DC link capacitor
710 step for providing voltage

1. A device for discharging a DC link capacitor comprising:
a discharge unit configured to:
discharge the DC link capacitor;
be interconnected between two terminal clamps on the DC link capacitor; and
control the discharging of the DC link capacitor by a control voltage at the discharge unit; and
a control unit configured to:
supply the control voltage to a control input on the discharge unit; and
vary the control voltage at least one of during the discharge process or at the start of the discharge process for the DC link capacitor.

2. The device according to claim 1, wherein the control unit is configured to vary the control voltage from a low voltage level to a high voltage level.

3. The device according to claim 1, wherein the control unit is configured to vary the control voltage at least one of evenly, linearly or monotonically.

4. The device according to claim 1, wherein the control unit further comprises an RC link for determining a voltage level of the control voltage.

5. The device according to claim 1, wherein the control unit is configured to cause a voltage jump in the control voltage at least one of at the start of a discharge process, for starting the discharge process, or after completion of the discharge process.

6. The device according to claim 1, wherein the control unit is configured to set the control voltage to a minimum value at the start of the discharge process.

7. The device according to claim 1, wherein the discharge unit comprises a power semiconductor switch.

8. The device according to claim 7, wherein the discharge unit comprises at least one of a MOSFET transistor or an IGBT.

9. The device according to claim 1, wherein the control unit is configured to determine the control voltage based at least in part on a temperature of at least one of the discharge unit or a component in the discharge unit.

10. The device according to claim 1, wherein the control unit comprises a first resistor connected in parallel to a second resistor by a first switch, wherein the first resistor and the second resistor are coupled to the control input on the discharge unit.

11. A DC link for conducting electricity from a power source to an actuator, wherein the DC link comprises:
a DC link capacitor; and
the device according to claim 1 coupled to the DC link capacitor,
wherein the device uses at least one component that is also used by an inverter connected to the DC link.

12. A method for discharging a DC link capacitor comprising:
supplying, by a control unit to a control input of a discharge unit, a control voltage; and
varying the control voltage at least one of during or at a start of a discharge process for the DC link capacitor.

13. A control unit configured to:
supply, to a control input of a discharge unit, a control voltage; and
vary the control voltage at least one of during or at a start of a discharge process for the DC link capacitor.

14. (canceled)

15. (canceled)

16. The device according to claim 1, wherein the control unit is configured to set the control voltage to a minimum value after completion of a discharge process when the discharge process was started at a maximum value for the control voltage.

17. The device according to claim 1, wherein the control unit comprises a second capacitor interconnected between the control input on the discharge unit and a contact on the DC link capacitor, wherein the second capacitor has a second switch configured to obtain a parallel connection of the second capacitor between the control input and the contact on the DC link capacitor.

18. The method according to claim 12, further comprising:
varying, by the control unit, the control voltage from a low voltage level to a high voltage level.

19. The method according to claim 12, further comprising:
varying, by the control unit, the control voltage at least one of evenly, linearly or monotonically.

20. The method according to claim 12, further comprising:
causing, by the control unit, a voltage jump in the control voltage at least one of at the start of a discharge process, for starting the discharge process, or after completion of the discharge process.

21. The method according to claim 12, further comprising:
determining, by the control unit, the control voltage based at least in part on a temperature of at least one of the discharge unit or a component in the discharge unit.

22. The method according to claim 12, further comprising:
controlling, by the control unit, a first switch to connect a first resistor in parallel to a second resistor, wherein the first resistor and the second resistor are coupled to the control input on the discharge unit; and
controlling, by the control unit, a second switch to selectively connect in parallel and disconnect a second capacitor between the control input on the discharge unit and a contact on the DC link.
